(19) United States
(12) Patent Application Publication
(10) Pub. No.: US 2013/0196848 A1
(43) Pub. Date: Aug. 1, 2013

(54) POROUS INORGANIC OXIDE PARTICLES AND METHODS OF MAKING AND USING THE SAME

(71) Applicants: Markus Kretzschmar, Altrip (DE); Horst Herrig, Bolanden (DE)

(72) Inventors: Markus Kretzschmar, Altrip (DE); Horst Herrig, Bolanden (DE)

(73) Assignee: GRACE GmbH & Co. KG, Worms (DE)

(21) Appl. No.: 13/642,695

(22) PCT Filed: May 19, 2011
(86) PCT No.: PCT/EP2011/002508

§ 371 Date: Mar. 21, 2013

Related U.S. Application Data
(60) Provisional application No. 61/347,076, filed on May 21, 2010.

(51) Int. Cl. B01J 20/28

(52) U.S. Cl. CPC B01J 20/28076
USPC 502/401; 502/400; 502/408; 502/407

(57) ABSTRACT

Porous inorganic oxide particles, such as porous silica particles, and compositions containing porous inorganic oxide particles are disclosed. Methods of making porous inorganic oxide particles and methods of using porous inorganic oxide particles are also disclosed.

### FIELD OF THE INVENTION

The present invention is directed to porous inorganic oxide particles, compositions containing porous inorganic oxide particles, methods of making porous inorganic oxide particles, and methods of using porous inorganic oxide particles.

### BACKGROUND OF THE INVENTION

Efforts continue in the art to further develop porous inorganic oxide particles, such as silica particles, having a desired combination of properties. For example, efforts continue to develop porous inorganic oxide particles, such as silica particles, having a desired average particle size and/or a desired particle size distribution; an increased BET surface area relative to known porous inorganic oxide particles; an increased oil absorption value, such as a DOA oil absorption value, relative to known porous inorganic oxide particles; an increased pore volume relative to known porous inorganic oxide particles; an increased particle stability relative to known porous inorganic oxide particles; or any combination of the above-referenced properties.

### SUMMARY OF THE INVENTION

The present invention addresses some of the difficulties and problems discussed above by the discovery of porous inorganic oxide particles having a combination of properties that were previously unknown to similar porous inorganic oxide particles.

In some exemplary embodiments, the porous inorganic oxide particles of the present invention comprise a single point nitrogen adsorption surface area of at least about 650 m²/g.

In some exemplary embodiments, the porous inorganic oxide particles of the present invention comprise (a) a single point nitrogen adsorption surface area of at least about 650 m²/g; and (b) a DOA oil absorption number of at least about 260 ml/100 g. In one exemplary embodiment, the porous inorganic oxide particles having this combination of properties comprise silica particles.

In some exemplary embodiments, the porous inorganic oxide particles of the present invention possess a porosity such that at least about 0.5 cc/g of pore volume, as measured by BJH nitrogen porosimetry, stems from pores having a pore size of 100 Å or smaller, wherein the porosity of the particles is measured after drying the particles at 200° C. for at least 2 hours followed by an activation at 200° C. for two hours under vacuum. In other exemplary embodiments, the porous inorganic oxide particles of the present invention possesses a porosity such that at least about 0.6 cc/g of pore volume, as measured by BJH nitrogen porosimetry, stems from pores having a pore size of 160 Å or smaller, wherein the porosity of the particles is measured after drying the particles at 200° C. for at least 2 hours followed by an activation at 200° C. for two hours under vacuum. In one exemplary embodiment, the porous inorganic oxide particles having this combination of properties comprise precipitated silica particles.

In some exemplary embodiments, the semi-finished porous inorganic oxide particles of the present invention comprise (a) a median particle size of at least about 1 micron; and (b) a particle stability of at least about 55% as measured using the Particle Stability test method discussed below. In one exemplary embodiment, the porous inorganic oxide particles having this combination of properties comprise precipitated silica particles.

The present invention is also directed to methods of making porous inorganic oxide particles having a desired combination of particle properties. In one exemplary method, the method of making porous inorganic oxide particles comprises the steps of forming precipitated inorganic oxide particles within a reaction mixture; separating the precipitated inorganic oxide particles from liquid within the reaction mixture; washing the precipitated inorganic oxide particles to produce washed precipitated inorganic oxide particles; and drying the washed precipitated inorganic oxide particles to form dried porous inorganic oxide particles. In one exemplary embodiment, the exemplary method of making porous inorganic oxide particles is utilized to form porous silica particles having one or more of the combination of properties disclosed herein.

In another exemplary method, the method of making porous inorganic oxide particles comprises the steps of introducing inorganic oxide particle-forming reagents into a reaction vessel, while mixing under high shear, for a first length of time so as to result in a first reaction mixture; following the first length of time, halting introduction of inorganic oxide particle-forming reagents into the reaction vessel while continuing the mixing under high shear for a second length of time; following the second length of time, introducing the inorganic oxide particle-forming reagents into the reaction vessel, while mixing under high shear, for a third length of time so as to result in a second reaction mixture; following the third length of time, acidifying the second reaction mixture so as to reduce the pH of the second reaction mixture to about 4.0 resulting in a third reaction mixture; separating precipitated inorganic oxide particles from the third reaction mixture; washing the precipitated inorganic oxide particles to produce washed precipitated inorganic oxide particles; and drying the washed precipitated inorganic oxide particles to form dried porous inorganic oxide particles. In one exemplary embodiment, the exemplary method of making porous inorganic oxide particles is utilized to form porous silica particles having one or more of the combination of properties disclosed herein.

The present invention is further directed to methods of using porous inorganic oxide particles. In some exemplary methods of using porous inorganic oxide particles, the method comprises utilizing semi-finished (e.g., unmilled) porous inorganic oxide particles, formed by the disclosed methods, in a given application (e.g., as a beer clarification agent, as a catalyst carrier, as a desiccant). In other exemplary methods of using porous inorganic oxide particles, the method comprises utilizing finished (e.g., milled) porous inorganic oxide particles, formed by the disclosed methods, in a given application (e.g., as a matting agent, as a filtering agent in beer stabilization, as a free flow agent).

These and other features and advantages of the present invention will become apparent after a review of the following detailed description of the disclosed embodiments and the appended claims.

### BRIEF DESCRIPTION OF THE FIGURES

FIG. 1 depicts a block diagram of an exemplary process for forming porous inorganic oxide particles of the present invention; and

FIG. 2 depicts a schematic diagram of an exemplary apparatus for forming porous inorganic oxide particles of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “high shear” means a stress which is applied parallel or tangential to a face of a material, as opposed to a normal stress which is applied perpendicularly. A high shear mixer uses a rotating impeller or high speed rotor, or a series of such impellers or inline rotors, usually powered by an electric motor, to “work” the fluid, creating flow and shear. The velocity, or tip speed of the fluid at the outside diameter of the rotor will be higher than the velocity at the centre of the rotor, and it is this that creates shear. Tip speeds above 20 m/s typically provide high shear conditions, but liquid viscosities and mixer design will also affect shear conditions.

As used herein, the term “inorganic oxide” is defined as binary oxygen compounds where metal is the cation and the oxide is the anion. The metals may also include metalloids or semi-metals. Metals include those elements on the left of the diagonal line drawn from boron to polonium on the periodic table. Metalloids or semi-metals include those elements that are on the right of this line. Examples of inorganic oxides include silica, alumina, titanic, zirconia, etc., and mixtures thereof.

As used herein, the term “particle” or “particulate” refers to porous or nonporous particles formed via any known process including, but not limited to, a solution polymerization process such as for forming colloidal particles, a continuous flame hydrolysis technique such as for forming fused particles, a gel technique such as for forming gelled particles, and a precipitation technique such as for forming precipitated particles, or combinations of thereof. The particles may be composed of organic and/or inorganic materials and combinations thereof. In one exemplary embodiment the particles are composed of inorganic materials such as inorganic oxides, sulfides, hydroxides, carbonates, silicates, phosphates, etc, but are preferably inorganic oxides. The particles may be a variety of different symmetrical, asymmetrical or irregular shapes, including chain, rod or lath shape. The particles may have different structures including amorphous or crystalline, etc. The particles may include mixtures of particles comprising different compositions, sizes, shapes or physical structures, or that may be the same except for different surface treatments, which render them hydrophobic. Preferably, the inorganic oxide particles are amorphous.

As used herein, the term “particle stability” means the measure of particle deagglomeration under shear force pursuant to the Particle Stability Test referenced herein.

As used herein, the term “pore size” means the diameter of the pores.

As used herein the term “porous particles” means particles having significant internal porosity as measured by nitrogen porosimetry, i.e., a porosity of more than about 0.05 cc/g, and the term “non-porous” means particles having little or no internal porosity, i.e., an internal porosity of less than about 0.05 cc/g. Examples of porous particles include, silica gel, precipitated silica, fumed silica, boehmite alumina, etc., and examples of non-porous particles include colloidal silica, alumina, titania, etc.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

As used herein, the term “rapid drying” means accelerated drying of newly formed inorganic oxide particles that may be performed by equipment with evaporative capacities of from about 200 to about 800 kg/(m²/h). Rapid drying is typically performed in less than two minutes such that the particles possess a moisture level of less than 10% by weight of the particle, and even less than 5% by weight of the particle.

In one exemplary embodiment, the present invention is directed to porous inorganic oxide particles, such as porous silica particles. In another exemplary embodiment, the present invention is further directed to methods of making porous inorganic oxide particles, such as porous silica particles, as well as methods of using porous inorganic oxide particles, such as porous silica particles. A description of exemplary porous inorganic oxide particles, exemplary methods of making porous inorganic oxide particles, and exemplary methods of using porous inorganic oxide particles is provided below.

### I. Porous Inorganic Oxide Particles

The porous inorganic oxide particles of the present invention have a physical structure and properties that enable the porous inorganic oxide particles to provide one or more advantages when compared to known precipitated porous inorganic oxide particles.

The porous inorganic oxide particles of the present invention may be characterized as “semi-finished” or “finished” particles. As used herein, the term “semi-finished particles” refers to un-milled particles, namely, particles that are not further processed following formation (discussed below). As used herein, the term “finished particles” refers to milled particles, namely, particles that are milled, ground and/or classified following a drying step. As discussed further below, the disclosed methods of making porous inorganic oxide particles provide a unique property set for both “semi-finished” and “finished” particles of the present invention, which enable the “semi-finished” and “finished” particles to be suitable for use in a variety of applications (as discussed further below).

The porous inorganic oxide particles of the present invention may have any shape, which depends upon the method of particle formation. For example, if the particles are formed by spray drying, they may be spherical, and when formed by other means, may be irregular. In one exemplary embodiment, the particles of the present invention have an irregular particle shape with an average largest particle dimension (i.e., a largest length, width or diameter dimension). In one exemplary embodiment, the semi-finished porous inorganic oxide particles of the present invention have an average largest particle dimension of less than about 50 microns (μm), more typically, less than about 30 μm. In another exemplary embodiment of the present invention, the semi-finished porous inorganic oxide particles have an average largest particle dimension of from about 15 μm to about 30 μm, and even from about 18 μm to about 25 μm. In some embodiments the particle size distribution of the semi-finished particles may range from about 1 to about 300 microns, and even from about 1 to about 200 microns.

Semi-finished particles of the present invention may be milled and/or classified to form “finished” particles having a desired average particle size and particle size distribution. In one exemplary embodiment, the finished porous inorganic oxide particles of the present invention have an average largest particle dimension of less than about 30 microns (μm), more typically, less than about 20 μm. In another exemplary embodiment of the present invention, the finished porous inorganic oxide particles have an average largest particle dimension of from about 1 μm to about 20 μm, and even from about 3 μm to about 15 μm. In some embodiments the particle size distribution of the finished particles may range from about 0.1 to about 100 microns, and even from about 0.1 to about 50 microns.

The porous inorganic oxide particles of the present invention typically have an aspect ratio of less than about 1.4 as measured, for example, using Transmission Electron Microscopy (TEM) techniques. As used herein, the term “aspect ratio” is used to describe the ratio between (i) the average largest particle dimension of the porous inorganic oxide particles and (ii) the average largest cross-sectional particle dimension of the porous inorganic oxide particles, wherein the cross-sectional particle dimension is substantially perpendicular to the largest particle dimension of a given porous inorganic oxide particle. In some embodiments of the present invention, the porous inorganic oxide particles have an aspect ratio of less than about 1.3 (or less than about 1.2, or less than about 1.1, or less than about 1.05). In another embodiment, the porous inorganic oxide particles have an aspect ratio of from about 1.0 to about 1.2.

In some embodiments, the semi-finished particles of the present invention have a particle stability of at least about 50% as measured via the Particle Stability Test method described below. In other embodiments, semi-finished particles of the present invention have a particle stability of at least about 55% (or at least about 60%, or at least about 65%, or at least about 70%, or at least about 72%) as measured via the Particle Stability Test method.

In some embodiments, the finished particles of the present invention have a particle stability of at least about 90% as measured via the Particle Stability Test method described below. In other embodiments, finished particles of the present invention have a particle stability of at least about 95% (or at least about 96%, or at least about 97%, or at least about 98%, or at least about 99%) as measured via the Particle Stability Test method.

In some exemplary embodiments, the porous inorganic oxide particles of the present invention (e.g., the finished particles) may have a specific surface area, as measured by the single point nitrogen adsorption method, of at least about 650 m²/g. In some exemplary embodiments, the porous inorganic oxide particles have a specific surface area of from about 650 to about 1000 m²/g. In other exemplary embodiments, the porous inorganic oxide particles have a specific surface area of from about 660 to about 900 m²/g, or even from about 670 to about 890 m²/g.

In some exemplary embodiments, the porous inorganic oxide particles of the present invention (e.g., the finished particles) also may have a DOA oil absorption number of at least about 200 ml/100 g. In some exemplary embodiments, the porous inorganic oxide particles have a DOA oil absorption number of from about 250 to about 400 ml/100 g. In other exemplary embodiments, the porous inorganic oxide particles have a DOA oil absorption number of from about 260 to about 380 ml/100 g.

In some exemplary embodiments, the porous inorganic oxide particles of the present invention (e.g., the finished particles) may have a specific surface area, as measured by the single point nitrogen adsorption method, of at least about 650 m²/g and a DOA oil absorption number of at least about 200 ml/100 g. In some exemplary embodiments, the porous inorganic oxide particles have a specific surface area of from about 650 to about 1000 m²/g and a DOA oil absorption number of from about 250 to about 400 ml/100 g. In other exemplary embodiments, the porous inorganic oxide particles have a specific surface area of from about 660 to about 900 m²/g, or even from about 670 to about 890 m²/g and a DOA oil absorption number of from about 260 to about 380 ml/100 g.

In further exemplary embodiments, the finished particles of the present invention may have a porosity such that at least about 0.5 cc/g of pore volume, as measured by BJH nitrogen porosimetry, is from pores having a pore size of 100 Å or smaller, wherein the porosity of the particles is measured after drying the particles at 200° C. for at least 2 hours followed by an activation at 200° C. for two hours under vacuum. In some exemplary embodiments, the finished particles may have a porosity such that at least about 0.6 cc/g of pore volume, as measured by BJH nitrogen porosimetry, is from pores having a pore size of 100 Å or smaller, wherein the porosity of the particles is measured after drying the particles at 200° C. for at least 2 hours followed by an activation at 200° C. for two hours under vacuum. In other exemplary embodiments, the finished particles possess a total porosity of at least about 1.5 cc/g of pore volume, at least about 1.6 cc/g of pore volume, at least about 1.7 cc/g of pore volume, at least about 1.8 cc/g of pore volume, at least about 1.9 cc/g of pore volume, or even at least about 2.0 cc/g of pore volume, as measured by BJH nitrogen porosimetry. In even further exemplary embodiments, the finished particles possess a total porosity of about 1.5 cc/g of pore volume to about 4.0 cc/g of pore volume, or about 1.7 cc/g of pore volume to about 3.0 cc/g of pore volume, as measured by BJH nitrogen porosimetry.

In further exemplary embodiments, the finished particles of the present invention may have a porosity such that at least about 0.6 cc/g of pore volume, as measured by BJH nitrogen porosimetry, is from pores having a pore size of 160 Å or smaller, wherein the porosity of the particles is measured after drying the particles at 200° C. for at least 2 hours followed by an activation at 200° C. for two hours under vacuum. In some exemplary embodiments, the finished particles may have a porosity such that at least about 0.7 cc/g of pore volume, as measured by BJH nitrogen porosimetry, is from pores having a pore size of 160 Å or smaller, wherein the porosity of the particles is measured after drying the particles at 200° C. for at least 2 hours followed by an activation at 200° C. for two hours under vacuum.

### II Methods of Making Porous Inorganic Oxide Particles

The present invention is also directed to methods of making porous inorganic oxide particles. Raw materials used to form the porous inorganic oxide particles of the present invention, as well as method steps for forming the porous inorganic oxide particles of the present invention are discussed below.

A. Raw Materials

The methods of making porous inorganic oxide particles of the present invention may utilize a number of porous inorganic oxide particle-forming raw materials. Suitable inorganic oxide particle-forming raw materials include, but are not limited to, alkali metal silicate (often mentioned in the literature as water glass), and sulfuric acid. Any commercially available water glass and sulfuric acid may be used in the present invention. In one exemplary embodiment, water glass, commercially available under the trade designation Sodium Silicate 38/40 from Woellner GmbH&Co.KG, Ludwigshafen, Germany, is used to form porous silica particles. Alternately, the alkali metal silicate used for making the inorganic oxides may be made by reaction of silicon dioxide and alkali metal carbonate when molten to form alkali metal silicate and carbon dioxide. The resulting alkali metal silicate is typically, after being cooled from the melt, in solid lump form, but it may be converted to powder form, or even into an aqueous solution.

B. Process Steps

The porous inorganic oxide particles of the present invention are typically prepared using a multi-step precipitation process, wherein porous inorganic oxide particles are precipitated under high shear, filtered to remove the porous inorganic oxide particles from the reaction slurry, washed as a crude filter cake to remove reaction residues, and then rapidly dried directly from the filter cake without the need for re-slurrying the particles. It has been discovered that the rapid drying step is of particular importance in controlling the pore structure of the resulting particles. The resulting porous inorganic oxide particles can then be used as-is or sized (e.g., milled) to an appropriately narrow particle size distribution by various means (e.g., mechanical classifier milling or fluid energy milling).

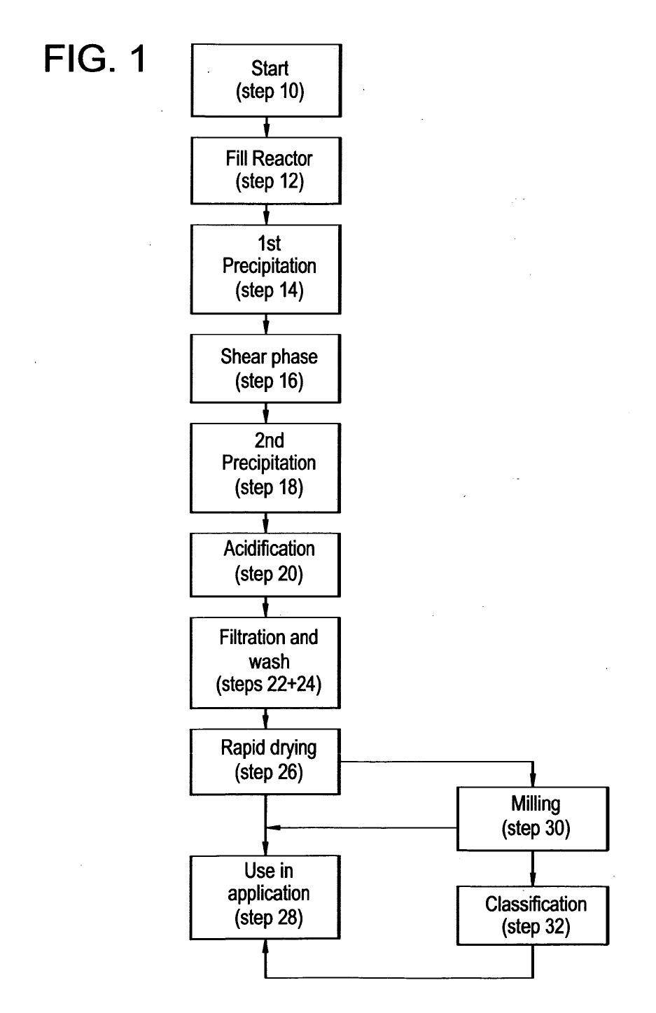

FIG. 1 depicts a block diagram of an exemplary process for forming porous inorganic oxide particles of the present invention. As shown in FIG. 1, exemplary process 100 begins at start block 10, and proceeds to a reactor fill step 12. In this step, a reactor vessel is filled with water (e.g., process or de-ionized water), which may be at a temperature of about 40° C.

From step 12, exemplary process 100 proceeds to a first precipitation step 14. In first precipitation step 14, inorganic oxide particle-forming reagents are introduced into the reaction vessel, while mixing under high shear. The inorganic oxide particle-forming reagents are independently fed into the reaction vessel at controlled feed rates, concentrations and temperatures for a first length of time so as to result in a first reaction mixture. Typically, the first length of time is less than 20 minutes, and more typically, between about 10 and 15 minutes. Desirably, mixing under high shear (e.g., up to 23 m/s nominal mixer tip speed) throughout exemplary process 100 comprises utilizing a high shear disintegrator (e.g., a DISPAX Reactor from IKA Works (Wilmington, N.C.)) in a bypass mode to circulate the inorganic oxide particle-forming reagents (and precipitated particles) through the reaction vessel and the high shear disintegrator. It is believed (without being bound therewith to any particular theory) that the use of the high shear mixing during the first precipitation step allows for control the particle size in the slurry at this stage of the reaction leading to, or at least supporting, the resulting desirable properties of the present invention particles.

From step 14, exemplary process 100 proceeds to a shear phase step 16, wherein introduction of inorganic oxide particle-forming reagents into the reaction vessel is halted, and mixing under high shear continues for a second length of time. Typically, the second length of time is less than 120 minutes, and more typically, between about 75 and 100 minutes. It is also believed (without being bound therewith to any particular theory) that the use of the high shear mixing during the shear phase step allows for control the particle size in the slurry at this stage of the reaction leading to, or at least supporting, the resulting desirable properties of the present invention particles.

From step 16, exemplary process 100 proceeds to a second precipitation step 18. As in first precipitation step 14, in second precipitation step 18, the inorganic oxide particle-forming reagents are again independently fed into the reaction vessel at controlled feed rates and concentrations under use of high shear mixing for a third length of time so as to result in a second reaction mixture. Typically, the third length of time is less than 60 minutes, and more typically, between about 30 and 45 minutes. It is further believed (without being bound therewith to any particular theory) that the use of the high shear mixing during the second precipitation step allows for control the particle size in the slurry at this stage of the reaction leading to, or at least supporting, the resulting desirable properties of the present invention particles.

From step 18, exemplary process 100 proceeds to an acidification step 20, wherein acid is introduced into the second reaction mixture so as to reduce the pH of the second reaction mixture to about 4.0 resulting in a third reaction mixture. Following step 20, exemplary process 100 proceeds to a filtration step 22, wherein precipitated inorganic oxide particles are physically separated from the liquid of the third reaction mixture, using suitable filtration equipment (e.g. drum filter, belt filter, filter press, membrane filter).

From step 22, exemplary process 100 proceeds to a washing step 24, wherein the precipitated inorganic oxide particles are washed with water (e.g., process or de-ionized water) resulting in washed precipitated inorganic oxide particles in the form of a filter cake. Alternatively, steps 22 and 24 may be performed on the same device in one operating step. From step 24, exemplary process 100 proceeds to a rapid drying step 26, wherein the washed precipitated inorganic oxide particles filter-cake is rapidly dried without prior re-slurrying to form dried porous inorganic oxide particles.

Rapid drying step 26 typically comprises the following sequence of drying steps. In one exemplary rapid drying step 26, washed precipitated inorganic oxide particles (i.e., filter-cake) are subjected to a rapid drying temperature ranging from about 300 to about 800° C., or 400 to about 700° C., for a rapid drying period of less than 5 minutes, or 4 minutes, or 3 minutes, or 2 minutes, or even less than 1 minute.

Unlike known spray-drying techniques, rapid drying step 26 is suitable for drying washed precipitated inorganic oxide particles without the need for one or more re-slurrying steps required in known spray-drying techniques, which makes the processing considerably more economic since this eliminates raw material costs, processing time, and energy costs (due to reduced water evaporation effort required per kg of product produced). Washed precipitated inorganic oxide particles (filter-cake) proceed directly to a dryer in rapid drying step 26 from washing step 24.

From step 26, exemplary process 100 may proceed directly to step 28, wherein the resulting dried inorganic oxide particles (i.e., the semi-finished particles) are used in a given application without further processing (e.g., without milling and/or granulating). In other embodiments, exemplary process 100 may proceed to a milling step 30, wherein the dried precipitated inorganic oxide particles are milled to a desired size. In one exemplary embodiment, milling step 30 results in milled dried porous inorganic oxide particles (i.e., finished particles) having an average particle size ranging from about 1 to about 30 microns.

From milling step 30, exemplary process 100 may proceed to an optional classifying step 32, wherein the milled particles are separated by particle size to produce a plurality of milled particles having a relatively narrow particle size distribution. From step 32, exemplary process 100 proceeds to step 28, wherein the resulting dried inorganic oxide particles (i.e., the finished particles) are used in a given application. In an especially preferred embodiment of the invention, the milling and the classifying step are performed on the same equipment (a so called classifier mill). The semi-finished product may also be classified using a sifter without an upstream comminution process.

In some desired embodiments, milling step 30 comprises subjecting the dried porous inorganic oxide particles to a fluid energy milling step so as to form finished porous inorganic oxide particles having an average particle size ranging from about 1 to about 25 microns, and a particle size distribution ranging from less than 1 to about 50 microns. Following the milling step 30, the particles may be packaged for shipment or mixed with various components depending upon the application or formulation desired. Alternatively, the particles may be further processed by surface treating the particles with an organic coating, such as wax, silane, etc. Such treatments are described in DE 1 006 100, DE 1 592 865, U.S. Pat. No. 5,221,337 and U.S. Pat. No. 6,294,505, the entire subject matter of which is incorporated herein by reference.

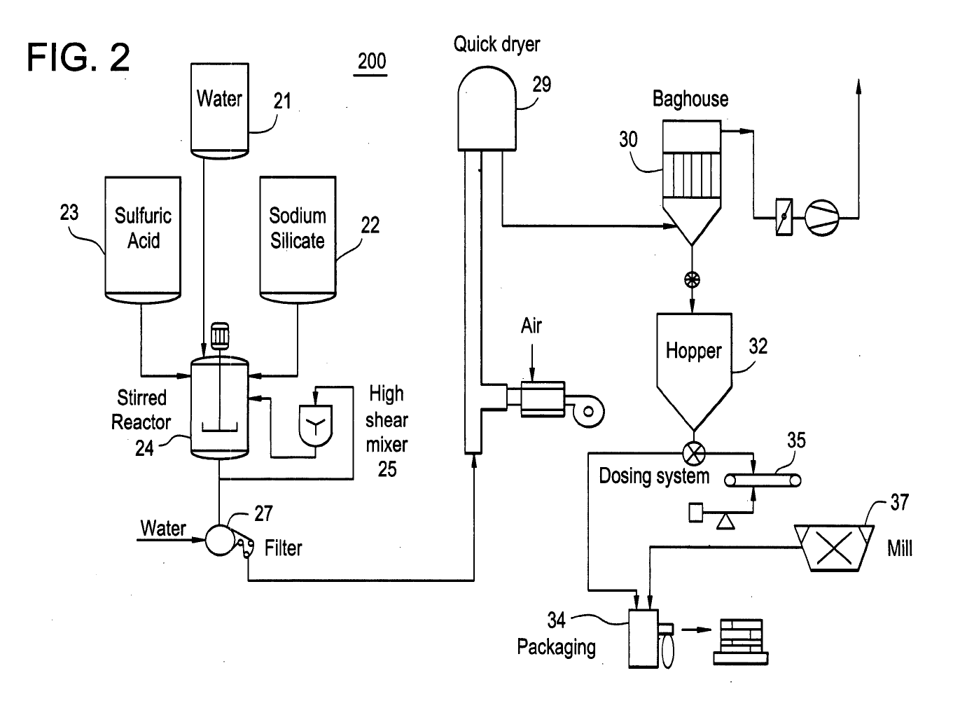

FIG. 2 depicts a schematic diagram of an exemplary process for forming porous inorganic oxide particles of the present invention. As shown in FIG. 2, tanks 21, 22, and 23 feed raw materials, such as water sulfuric acid and sodium silicate, into reactor 24. A high shear mixer 25 provides shear on the contents of the reactor 24. Following the reaction, inorganic oxide particles that have been formed are sent to belt filter 27 where they are drained and/or filtered and washed, which forms a filter cake. Subsequently, the filter cake is moved to the rapid dryer 29, where the particles are dried over a short period of time such that the moisture level of the particles are less than 10% by weight based upon the weight of the particles. The gas stream exiting the dryer 29 is directed to a baghouse 30 where the particles are collected and subsequently sent to a hopper 32 where the particles are classified, such as by use of a sifter (not shown) and sent to a packaging station 34 or sent to a mill 37 via dosing system 35. After milling, the particles may be sent to packing station 34.

III. Methods of using Porous Inorganic Oxide Particles

The present invention is further directed to methods of using porous inorganic oxide particles. In some exemplary methods of using porous inorganic oxide particles, the methods comprise utilizing semi-finished (e.g., minified particles; particles “as-is” after exiting the dryer without further processing) porous inorganic oxide particles, formed by the disclosed methods, in a given application. Applications in which semi-finished porous inorganic oxide particles may be used include, but are not limited to, utilizing the semi-finished particles as a beer clarification agent, utilizing the semi-finished particles as a catalyst carrier, and utilizing the semi-finished particles as a desiccant.

In other exemplary methods of using porous inorganic oxide particles, the method comprises utilizing finished (e.g., milled particles undergoing at least one milling step after exiting the dryer) porous inorganic oxide particles, formed by the disclosed methods, in a given application. Applications in which finished porous inorganic oxide particles may be used include, but are not limited to, utilizing the finished particles as a matting agent in various coatings, anti-block agents in plastic films, fillers in polymers, thickeners in liquids, abrasives or thickeners in toothpastes, additives in cosmetic formulations, filtering agents in beer stabilization or edible oil purification, and the like.

In other exemplary embodiments, methods of using porous inorganic oxide particles of the present invention may comprise utilizing the porous inorganic oxide particles in applications including, but not being limited to, as a filler/reinforcing material in rubber, tires, shoe soles; as anti-caking additive or free flow agent in powdered or liquid materials (e.g., cosmetics, salts and foods); as a filler material in adhesives, paints and colorants, health care products such as toothpaste, other pastes, ointments and cosmetics, and pharmaceuticals.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims. For example, even though the examples describe precipitated silica particles, other inorganic oxides may be prepared using similar techniques without undue experimentation.

### EXAMPLES

The following materials and test methods were used in the examples below.

### Materials:

The following materials were used in the examples.

TABLE 1
Materials

| Material | Product Name | Source |
|---|---|---|
| sulfuric acid | Sulfuric Acid | Th. Goldschmidt AG, Essen, |
| | | Germany |
| water glass liquid | Sodium Silicate | Woellner GmbH&Co. KG, |
| | 38/40 | Ludwigshafen, Germany |
| water | Process water | Deep well |

### Test Methods:

Particle Size Test Method

The average particle size of a plurality of particles is determined using the particle size test method as described in ISO/FSD 13320-1.

Particle Single Point Nitrogen Adsorption Surface Area Test Method

The average surface area of a plurality of particles is determined as described in ISO 5794-1:2005.

DOA Oil Absorption Test Method

The oil absorption of a plurality of particles is determined using the oil absorption test method as described in ASTM D 2414 Method B, with the use of DOA (dioctyladipate) as the penetrating oil.

Particle Stability Test Method

In this test, a plurality of semi-finished particles are tested for their stability after milling. The particle stability index is the quotient of the median particle size from 2 particle size measurements on the same sample according to ISO/FSD 13320-1. Sample preparation is conducted with two different intensities of ultrasonic pretreatment. About 1 g of silica is put into a 150 ml beaker and 100 to 120 ml of deionized water is added thereto. The tip of the ultrasonic resonator (Branson Sonifier W250D) is immersed 2 cm into the fluid and in the center of the beaker. The sonification is conducted with a power setting of 55% for 10 s for measurement 1 and 60 s for measurement 2. The particle stability index is calculated as follows:

Stability Index [%]=(d0.5_{60 s)})/(d0.5_{10 s})*100

Particle Pore Volume Test Method

The average pore volume of a plurality of particles is determined using the BJH nitrogen porosimetry as described in DIN 66134.

### Example 1

### Preparation of Porous Semi-Finished Silica Particles

A reaction vessel was filled with 175.5 liter of distilled deionized (via ion-exchange) water having a temperature of 40° C. The reaction vessel was in fluid communication with a DISPAX™ reactor (i.e., an inline, high shear disintegrator commercially available under the trade designation DISPAX™ Reactor DR2000 from IKA Works (Wilmington, N.C.)). The DISPAX™ Reactor DR2000 was operating in a bypass mode using the following settings: tip speed 23 m/s, flow rate=2500 l/h.

In a first precipitation step, H₂SO₄ (97%) and WGL38/40 were simultaneously fed into the system while mixing under high shear. 1150 g of H₂SO₄ (97%) was fed into the system at a feed rate of 88.5 g/min. 8437 g of WGL38/40 was fed into the system at a feed rate of 649 g/min. The reactants are added at room temperature and the reactor is maintained at atmospheric pressure.

Once the 1150 g of H₂SO₄ (97%) and the 8437 g of WGL38/40 were in the system, the reaction mixture was circulated through the system, under high shear, at a flow rate of 2500 l/h for a period of 90 minutes (i.e., the shear phase).

Following the shear phase, a second precipitation step was initiated. In the second precipitation step, 3805 g of H₂SO₄ (97%) was fed into the system at a feed rate of 88.5 g/min, while 27907 g of WGL38/40 was simultaneously fed into the system at a feed rate of 649 g/min.

Once the additional 3805 g of H₂SO₄ (97%) and the additional 27907 g of WGL38/40 were in the system, the pH of the reaction mixture was reduced, under high shear, to a pH of 4.0. The resulting acidified reaction mixture was filtered using a membrane filter press to separate precipitated inorganic oxide particles from the acidified reaction mixture. The separated precipitated inorganic oxide particles were washed and then introduced into a dryer (Lab Scale Flash Drier), commercially available under the trade designation Anhydro from Soeborg, Denmark, and rapidly dried at 350° C. so that the particles possessed less than 10% moisture based upon the weight of the particles. The particles of Sample 1 have an average particle size of 11.7 microns. The particles of Sample 2 have an average particle size of 23.7 microns. The particles of Sample 3 have an average particle size of 12.9 microns. For Sample 4, a semi-finished precipitated silica was selected (after milling is commercially available from Grace GmbH & Co. KG as Perkasil® KS408 silica).

The resulting semi-finished inorganic oxide particles were tested to determine average particle size, and particle stability using the above-described test methods. The results are provided in Table 2 below.

TABLE 2
Semi-Finished Silica Particle Properties

| | Average Particle | Average Particle |
|---|---|---|
| Sample | Size (μm) | Stability |
| 1 | 11.7 | 91% |
| 2 | 23.7 | 99% |
| 3 | 12.9 | 81% |
| 4 | 36.4 | 51% |

As is apparent from Table 2, the average Particle Stability is quite high for Sample 1-3, whereas the average Particle Stability for Sample 4 is quite low.

### Example 2

### Preparation of Porous Finished Silica Particles

The semi-finished silica particles formed in Example 1 were subjected to a fluid energy milling step as follows. The semi-finished silica from Example 1 is fed into an air jet mill available from Netzsch-Condux Mahltechnik GmbH at a rate of 250 kg/h. The mill is operated at an air flow rate of 400 m³/h and a temperature above 200 degrees centigrade, and the particles are milled until the average particle size is less than 10 microns. The particles are collected in a baghouse and their properties measured. Acematt HK400, available from Evonik Industries, is used as a comparison Sample 8.

The resulting finished inorganic oxide particles were tested to determine average particle size, single point nitrogen adsorption surface area, DOA oil absorption number, and pore volume using the above-described test methods. The results are provided in Table 3 below.

TABLE 3
Finished Silica Particle Properties

| | Average | Surface | DOA Oil | Pore |
|---|---|---|---|---|
| | Particle Size | Area | Absorption | Volume |
| Sample | (μm) | (m²/g) | (ml/100 g) | (cc/g) |
| 5 | 8.9 | 853 | 321 | 1.95 |
| 6 | 5.9 | 853 | 351 | 1.95 |
| 7 | 5.2 | 805 | 295 | 2.03 |
| 8 | 5.2 | 226 | 270 | 1.90 |

As is apparent from Table 3, the average single point surface area and DOA oil adsorption are quite high for Sample 5-7, whereas the single point surface area and DOA oil adsorption are much lower for Sample 8.

### Example 3

### Preparation of Porous Finished Silica Particles

The semi-finished silica particles formed in Example 1 were subjected to a mechanical classifier milling step as follows. The semi-finished silica from Example 1 is fed into a CSM classifier mill available from Netzsch-Condux Mahltechnik GmbH at a rate of 750 kg/h. The mill is operated at maximum circumferential speed and the particles are milled until the average particle size is less than 10 microns. The particles are collected in a baghouse and their properties measured. Lo-vel 600, available from PPG Industries, is used as a comparison Sample 12.

The resulting finished inorganic oxide particles were tested to determine average particle size, single point nitrogen adsorption surface area, DOA oil absorption number, and pore volume using the above-described test methods. The results are provided in Table 4 below.

TABLE 4
Finished Silica Particle Properties

| | Average | Surface | DOA Oil | Pore |
|---|---|---|---|---|
| | Particle Size | Area | Absorption | Volume |
| Sample | (μm) | (m²/g) | (ml/100 g) | (cc/g) |
| 9 | 9.2 | 785 | 325 | 1.91 |
| 10 | 9.1 | 734 | 314 | 1.83 |
| 11 | 9.5 | 757 | 330 | 1.82 |
| 12 | 10.4 | 660 (BET) | 250 | 1.70 |

As is apparent from Table 4, the average single point surface area and the DOA oil adsorption number are quite high for Sample 9-11, whereas the single point surface area and the DOA oil adsorption number are much lower for Sample 12.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A method of making porous inorganic oxide particles, said method comprising the steps of:
forming precipitated inorganic oxide particles within a reaction mixture while mixing under high shear conditions;
separating the precipitated inorganic oxide particles from liquid within the reaction mixture;
washing the precipitated inorganic oxide particles to produce washed precipitated inorganic oxide particles; and
rapid drying the washed precipitated inorganic oxide particles to form dried porous inorganic oxide particles.

2. The method of claim 1, wherein said forming step comprises:
introducing inorganic oxide particle-forming reagents into a reaction vessel, while mixing under high shear conditions, for a first length of time so as to result in a first reaction mixture;
following the first length of time, halting introduction of inorganic oxide particle-forming reagents into the reaction vessel while continuing said mixing under high shear dispersion force for a second length of time;
following the second length of time, introducing the inorganic oxide particle-forming reagents into the reaction vessel, while mixing under high shear, for a third length of time so as to result in a second reaction mixture; and
following the third length of time, acidifying the second reaction mixture under high shear dispersion force so as to reduce a pH of the second reaction mixture to about 4.0 resulting in a third reaction mixture.

3. The method of claim 2, wherein the inorganic oxide particle-forming reagents comprise alkali metal silicate and sulfuric acid.

4. The method of claim 2, wherein said mixing under high shear comprises utilizing a high shear disintegrator in a bypass mode to circulate the inorganic oxide particle-forming reagents through the reaction vessel and the high shear disintegrator.

5. The method of claim 2, wherein the first length of time is less than about 15 minutes, the second length of time is less than about 120 minutes, and the third length of time is less than about 45 minutes.

6. The method of claim 5, wherein the first length of time is about 13 minutes, the second length of time is about 90 minutes, and the third length of time is about 43 minutes.

7. The method of claim 1, wherein the precipitated inorganic oxide particles from said separating step are fed directly as a filter cake to a rapid dryer utilized in said rapid drying step without a re-slurrying step therebetween.

8. The method of claim 1, wherein the precipitated inorganic oxide particles are subjected to a rapid drying temperature ranging from about 300° C. to about 700° C. for a rapid drying period of from about 2 seconds to about 2 minutes during said rapid drying step.

9. The method of claim 1, further comprising:
milling or classifying the dried porous inorganic oxide particles to form finished porous inorganic oxide particles having an average particle size ranging less than about 30 microns.

10. The method of claim 9, wherein said milling step comprises subjecting the dried porous inorganic oxide particles to a fluid energy milling step so as to form finished porous inorganic oxide particles having an average particle size ranging from about 0.1 to about 30 microns, and a particle size distribution ranging from about less than 1 to about 100 microns.

11. Silica particles formed by the method of claim 1, wherein said silica particles are semi-finished and have:
(a) a median particle size of more than about 1.0 microns; and
(b) a particle stability of at least about 55% as measured via the Particle Stability Test Method.

12. Silica particles formed by the method of claim 9, said silica particles having:
(a) a single point nitrogen adsorption surface area of at least about 650 m²/g; and
(b) a DOA oil absorption number of at least about 260 ml/100 g.

13. Silica particles formed by the method of claim 9, said silica particles having a porosity such that at least about 0.5 cc/g of pore volume, as measured by BJH nitrogen porosimetry, is from pores having a pore size of 100 Å or smaller, wherein the porosity of the particles is measured after drying the particles at 200° C. for at least 2 hours followed by an activation at 200° C. for two hours under vacuum.

14. Silica particles formed by the method of claim 9, said silica particles having a median particle size in the range of about 1 to about 30 microns.

15. A plurality of porous inorganic oxide particles, wherein the particles comprise:
(a) a single point nitrogen adsorption surface area of at least about 650 m²/g; and
(b) a DOA oil absorption number of at least about 260 ml/100 g.

16. The plurality of porous inorganic oxide particles of claim 14, wherein the particles comprise:
(a) a single point nitrogen adsorption surface area of from about 675 to about 1000 m²/g; and
(b) a DOA oil absorption number of from about 280 to about 360 ml/100 g.

17. The plurality of porous inorganic oxide particles of claim 14, wherein the particles comprise:
(a) a single point nitrogen adsorption surface area of from about 650 to about 1000 m²/g; and
(b) a DOA oil absorption number of from about 290 to about 350 ml/100 g.

18. The plurality of porous inorganic oxide particles of claim 14, wherein the porous inorganic oxide particles comprise silica particles.

19. The plurality of porous inorganic oxide particles of claim 14, wherein the porous inorganic oxide particles comprise precipitated particles.

20. The plurality of porous inorganic oxide particles of claim 14, wherein said particles possess a median particle size in the range of about 1 to about 30 microns.

21. The plurality of porous inorganic oxide particles of claim 14, wherein the particles comprise a porosity such that at least about 0.6 cc/g of pore volume, as measured by BJH nitrogen porosimetry, is from pores having a pore size of 160 Å or smaller, wherein the porosity of the particles is measured after drying the particles at 200° C. for at least 2 hours followed by an activation at 200° C. for two hours under vacuum.

22. A plurality of porous inorganic oxide particles, wherein the particles comprise a porosity such that at least about 0.5 cc/g of pore volume, as measured by BJH nitrogen porosimetry, is from pores having a pore size of 100 Å or smaller, wherein the porosity of the particles is measured after drying the particles at 200° C. for at least 2 hours followed by an activation at 200° C. for two hours under vacuum.

23. The plurality of porous inorganic oxide particles of claim 21, wherein the particles comprise a porosity such that at least about 0.6 cc/g of pore volume, as measured by BJH nitrogen porosimetry, is from pores having a pore size of 160 Å or smaller, wherein the porosity of the particles is measured after drying the particles at 200° C. for at least 2 hours followed by an activation at 200° C. for two hours under vacuum.

24. The plurality of porous inorganic oxide particles of claim 21, wherein said particles possess a median particle size in the range of about 1 to about 30 microns.

25. The plurality of porous inorganic oxide particles of claim 21, wherein the particles comprise a total porosity of at least about 1.5 cc/g of pore volume, as measured by BJH nitrogen porosimetry.

26. The plurality of porous inorganic oxide particles of claim 21, wherein the particles comprise a total porosity of at least about 1.7 cc/g of pore volume, as measured by BJH nitrogen porosimetry.

27. The plurality of porous inorganic oxide particles of claim 21, wherein the porous inorganic oxide particles comprise silica particles.

28. The plurality of porous inorganic oxide particles of claim 21, wherein the porous inorganic oxide particles comprise precipitated particles.

29. The plurality of porous inorganic oxide particles of claim 21, wherein said particles have a median particle size in the range of about 1 to about 30 microns.

30. A plurality of semi-finished porous inorganic oxide particles, wherein the particles comprise:
(a) a median particle size of more than about 1 microns; and
(b) a particle stability of at least about 55% as measured using the Particle Stability test method.

31. The plurality of porous inorganic oxide particles of claim 29, wherein the particle stability is at least about 60%.

32. The plurality of porous inorganic oxide particles of claim 29, wherein the particle stability is at least about 70%.

33. The plurality of porous inorganic oxide particles of claim 29, wherein the particles comprise a porosity such that at least about 0.6 cc/g of pore volume, as measured by BJH nitrogen porosimetry, is from pores having a pore size of 100 Å or smaller, wherein the porosity of the particles is measured after drying the particles at 200° C. for at least 2 hours followed by an activation at 200° C. for two hours under vacuum.

34. The plurality of porous inorganic oxide particles of claim 29, wherein the porous inorganic oxide particles comprise silica particles.

35. The plurality of porous inorganic oxide particles of claim 29, wherein the porous inorganic oxide particles comprise precipitated particles.

36. The plurality of porous inorganic oxide particles of claim 29, wherein said particles having a median particle size in the range of about 1 to about 30 microns.

37. A plurality of precipitated porous inorganic oxide particles, wherein the particles comprise a single point nitrogen adsorption surface area of at least about 650 m²/g.

38. The plurality of porous inorganic oxide particles of claim 36, wherein the particles comprise a single point nitrogen adsorption surface area of from about 660 to about 1000 m²/g.

39. The plurality of porous inorganic oxide particles of claim 36, wherein the particles comprise a single point nitrogen adsorption surface area of from about 670 to about 1000 m²/g.

40. The plurality of porous inorganic oxide particles of claim 36, wherein the particles comprise a DOA oil absorption number of at least about 260 ml/100 g.

41. The plurality of porous inorganic oxide particles of claim 36, wherein the particles comprise a DOA oil absorption number of from about 280 to about 360 ml/100 g.

42. The plurality of porous inorganic oxide particles of claim 36, wherein the particles comprise a DOA oil absorption number of from about 290 to about 350 ml/100 g.

43. The plurality of porous inorganic oxide particles of claim 36, wherein the porous inorganic oxide particles comprise silica particles.

44. The plurality of porous inorganic oxide particles of claim 36, wherein the porous inorganic oxide particles comprise precipitated particles.

45. The plurality of porous inorganic oxide particles of claim 36, wherein said particles have a median particle size in the range of about 1 to about 30 microns.

46. The plurality of porous inorganic oxide particles of claim 36, wherein said particles are treated with an organic material.

47. The plurality of porous inorganic oxide particles of claim 36, wherein said particles are treated with wax.
